(19) United States
(12) Patent Application Publication
(10) Pub. No.: US 2008/0291539 A1
(43) Pub. Date: Nov. 27, 2008

(54) Light reflective panel appliques

(76) Inventor: Dennis Moore, Cullom, IL (US)

Correspondence Address: MICHAEL L. ANTOLINE P.C., ONE EAST MAIN STREET, SUITE 212, CHAMPAIGN, IL, 61820, US

(21) Appl. No.: 12/006,594

(22) Filed: Jan. 5, 2008

Related U.S. Application Data
(60) Provisional application No. 60/927,036, filed on May 1, 2007.

(51) Int. Cl. G02B 5/12

(52) U.S. Cl. 359/549

(57) ABSTRACT

A tread plate for use on emergency vehicles wherein a number of dots of light reflective material are disposed between the treads allowing the tread plate itself to become light reflective. The creation of patterns using units of variously colored light reflective material to convey information or increase visibility. A new use for light reflective material.

### CROSS REFERENCE TO RELATED APPLICATIONS

This application claims the benefit of PPA Ser. No. 60/833,561 filed Jan. 5, 2007 and PPA 60/927,036 filed May 1, 2007.

### FEDERALLY SPONSORED RESEARCH

NOT APPLICABLE

### SEQUENCE LISTING OR PROGRAM

NOT APPLICABLE

### BACKGROUND OF THE INVENTION

### Field of Invention

This invention relates to safety equipment, specifically reflective material that may appear on an emergency vehicle to increase visibility.

### BACKGROUND

### Discussion of Prior Art

Reflective material which provides a display of reflected light when illuminated is seen in the prior art. However, the prior art reveals reflective material that is designed to be placed on or adhered to a flat surface. An example of this can be seen in U.S. Pat. No. 5,864,429 to Gold, where reflective tape was added to a rear van door window to provide a light display. Another example of=reflective material being placed on a flat surface is seen in U.S. Pat. No. 6,077,616 to Serafin et al. This was a reflective laminated strip that was designed to be placed on vehicle trim which is, again, a substantially flat surface as can be seen in FIGS. 2 through 4 of that patent. Generally, adhesive reflective material requires a large flat surface upon which to be applied. On modern emergency vehicles, often times the rear of the vehicles do not necessarily provide such a flat surface. Often, the rear of emergency vehicles exhibits rough or uneven surfaces such as that of tread plate which may be aluminum, steel or nickel or chrome coated metal. The surface of tread plate covered by thin diamond shaped raised areas which provide traction on what would otherwise be a slippery surface. Tread plate is often applied to both vertical and horizontal surfaces in modern emergency vehicles. For the purposes of this application, tread plate is define as that currently commercially available or any uneven surface. The problem with the current embodiments of reflective material, especially material that is adhesive in nature, is that it requires a flat surface to which to be applied. On tread plate specifically, the reflective material shown in the prior art could not be applied if placed over the diamond treads. Contact with equipment used at the scene of an emergency or foot traffic would abrade the reflective strip in those areas directly over the diamond treads. Consequently, the reflective nature of the strip would be diminished, the reflective material would shred and become a tripping hazard in itself and would produce an unsightly result.

### OBJECTS AND ADVANTAGES

Several objects and advantages of this invention over the prior art are first, the configuration of the reflective material allows it to be placed on surfaces that are not uniformly flat such as diamond tread plate. The reflective material in this configuration can be placed between the treads which allows a significant portion of the surface of emergency vehicles to become light reflective, thereby increasing dramatically the safety and the visibility factor of the emergency vehicle and its consequent safety. Positioning the reflective material between the raised areas of the diamond tread plate will protect them from abrasion and foot traffic. The safety value of the reflective material is apparent on vertical surfaces however, the reflective dots may also be used on horizontal surfaces such as those of steps. Ambient light at the scene of an emergency would illuminate the horizontal surface of the step which would increase the steps visibility.

The use of reflective material capable of being placed between raised surfaces such as the diamonds treads on diamond tread plate, allows large vertical areas of the emergency vehicles to be illuminated thereby increasing the visibility. Reflective material in this configuration may be placed on not only uneven but also on curved, spherical, concave, and convex surfaces. For example the surface on the tank of a tanker truck may be concave. Large reflective strips as seen in the prior art, if applied to this surface would result in a wrinkling and a consequent disruption of the reflective surface. Reflective material in the configuration as shown in the present invention, can be applied to such a surface without this disadvantage. The reflective material may be manufactured in various colors, by way of example and not limitation, orange, yellow, red, white and blue. By using various colors, designs or patterns can be created increasing the visibility. Such pattern examples might be straight lines of various colors, chevrons, numerals, letter, required Department of Transportation markings and slow moving vehicle triangles. The material manufactured to various sizes and shapes is much easier to apply than the current large reflective strips seen in the prior art.

Since the reflective material in the configuration seen in the present invention can be used on curved surfaces, it can be used to illuminate equipment apart from vehicles. For example, the dots can be applied to firefighter's helmets, tools and breathing apparatus, aiding in the location and recovery of this items in otherwise chaotic sites of emergencies.

### SUMMARY

The invention comprises reflective material manufactured to a size and shape by which it may be adhered to non-flat surfaces such as that of diamond tread plate.

### BRIEF DESCRIPTION OF THE DRAWINGS

FIG. 1 is a plan view of a tread plate with the reflective material in place of a circular shape.

FIG. 2 is a plan view of a tread plate with alternate configuration of treads and reflective material of a rectangular shape.

FIG. 3 is an elevation view of a tread plate with the reflective material in place.

FIG. 4 is an elevation view of a curved surface with a reflective material in place.

### PREFERRED EMBODIMENT

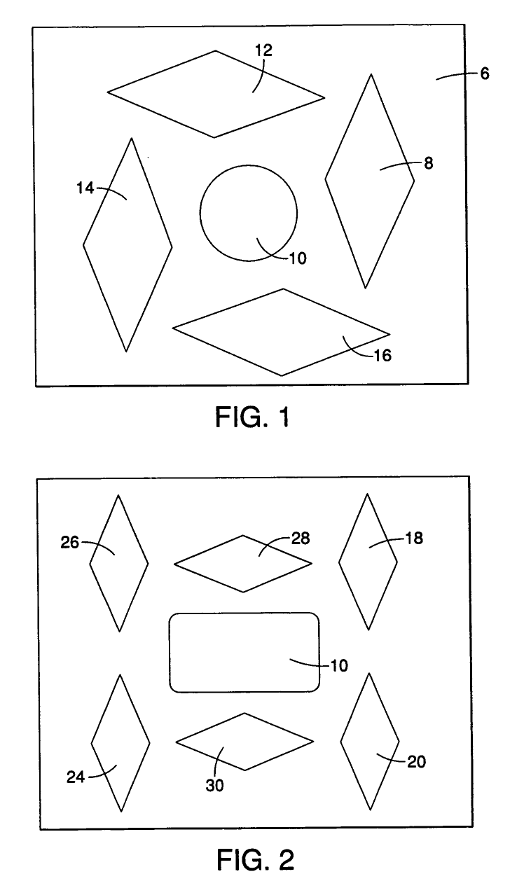

Turning now to FIG. 1, it can be seen that the plate surface 6 comprises the base of the tread. Treads 8, 12, 14, and 16 rise above the plate surface 6. The reflective material unit 10 is placed on plate surface 6 and between the treads 8, 12, 14, and 16. It should be noted that treads 8, 12, 14, and 16 may form a repeating pattern across the surface of a tread plate of any size. Treads 8, 12, 14, and 16, in conjunction with the reflective material unit may also form repeating patterns.

Turning now to FIG. 2, an alternative configuration of treads 18, 20, 22, 24, 26, and 28 is observed. This allows the reflective material 10 unit to adopt a shape different than seen in FIG. 1. The shape of the reflective material unit 10 may be altered in any way to facilitate placement between the treads. The configuration of tread patterns and consequent shapes of the reflective material is virtually infinite.

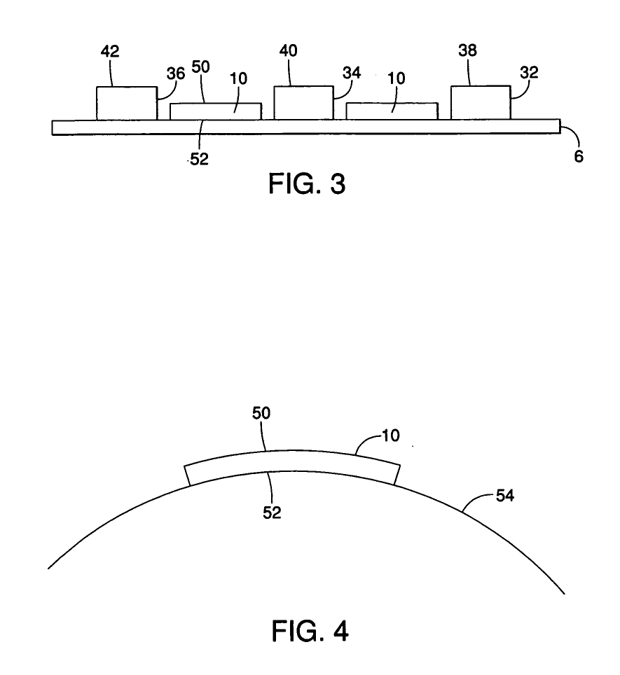

Turning now to FIG. 3 we see an elevation view of the tread plate, wherein tread 32, 34 and 36 rises from plate surface 6. Treads 32, 34 and 36 exhibit upper tread surfaces 38, 40 and 42 respectively. The reflective material unit 10 also exhibits an upper reflective material surface 50 and a lower reflective material surface 52. Lower reflective surface may be adhesive. It should be noted that the upper surfaces 50 and 52 of the reflective material 10 is below the upper tread surfaces 38, 40 and 42. This will help prevent mechanical abrasion from tearing or damaging the reflective material.

FIG. 4 illustrates reflective material 10 applied to curved surface 54. Because the surface area of the reflective material in the present invention is significantly reduced over large reflective strips a plurality of units of reflective material may cover a curved surface and provide a maximum area of reflectivity without wrinkling or tearing which would be the eventual result in using large sheets of reflective material currently reflected in the prior art.

What is claimed is:

1. A plurality of light reflective units disposed between a plurality of raised areas above a surface.

2. The surface of claim 1, wherein said surface becomes light reflective by application of said plurality of light reflective units.

3. The plurality light reflective units of claim 1 further comprising units that are colored with the spectrum of colors represented by decimal color codes between and including EEEEEE and 000000.

4. The surface of claim 1 further comprising a tread plate.

5. The raised areas of claim 1 further comprising treads.

6. The treads of claim 5 further comprising various patterns upon said surface resulting in the disposition of inter-tread spaces of a plurality of sizes and shapes between said treads.

7. The light reflective units of claim 1 further comprising a plurality of shapes substantially covering said inter-tread spaces.

8. The plurality of units of light reflective units of claim 3 where in said colored units are may be disposed whereby a design is formed.

9. A method of disposing light reflective units between a plurality of raised areas of above a surface whereby said surface is light reflective.

10. A tread plate wherein a plurality of light reflective units disposed between a plurality of treads increases the light reflectivity of said tread plate.

11. The tread plate of claim 10 further comprising a plurality of light reflective units colored with the spectrum of colors represented by decimal color codes between and including EEEEEE and 000000.

12. The tread plate of claim 10 further comprising light reflective units disposed in a pattern.
